(19) United States
(12) Patent Application Publication
(10) Pub. No.: US 2011/0296106 A1
(43) Pub. Date: Dec. 1, 2011

(54) SYSTEM FOR REALIZING MULTI-PORT STORAGE MEDIA BASED ON A UASP PROTOCOL OF A USB SPECIFICATION VERSION 3.0 AND METHOD THEREOF

(76) Inventors: Hsieh-Huan Yen, Taipei City (TW); Teng-Chuan Hsieh, New Taipei City (TW); Yu-Chiun Lin, Taipei City (TW)

(21) Appl. No.: 13/107,951

(22) Filed: May 15, 2011

Related U.S. Application Data
(60) Provisional application No. 61/350,027, filed on Jun. 1, 2010.
(60) Provisional application No. 61/357,077, filed on Jun. 21, 2010.

(30) Foreign Application Priority Data
Jan. 17, 2011 (TW) 100101628

(51) Int. Cl. G06F 12/00

(52) U.S. Cl. 711/115; 711/E12.001

(57) ABSTRACT

A system for realizing multi-port storage media based on a UASP protocol of a USB specification version 3.0 includes a Universal Serial Bus, at least one storage media, and a storage device, where the storage device stores a mapping table. The Universal Serial Bus is used for transmitting at least one write data command. Each storage media is used for replying a write ready command to the Universal Serial Bus after receiving a write data command. When the Universal Serial Bus transmits a data including a command tag according to the write ready command, the storage device finds a number mapping to the command tag according to the command tag and the mapping table, and transmits the data to a storage media mapping to the number.

### CROSS REFERENCE TO RELATED APPLICATIONS

This application claims the benefit of U.S. Provisional Application No. 61/350,027, filed on Jun. 1, 2010 and entitled “Method for Implementing Multi-Port Storage Media Based on UASP,” and the benefit of U.S. Provisional Application No. 61/357,077, filed on Jun. 21, 2010 and entitled “Method for Implementing Multi-Port Storage Media Based on UASP,” the contents of which are incorporated herein by reference.

### BACKGROUND OF THE INVENTION

1. Field of the Invention

The present invention is related to a system for realizing multi-port storage media and method thereof, and particularly to a system for realizing multi-port storage media based on a UASP protocol of a USB specification version 3.0 and method thereof.

2. Description of the Prior Art

In the prior art, a Universal Serial Bus (USB) utilizes serial transmission to transmit data or a command once, so transmission efficiency of the Universal Serial Bus is poor. A USB specification version 3.0 specifies a USB Attached SCSI Protocol (UASP), where the UASP protocol transmits a plurality of data or commands similar to operation in a small computer system interface (SCSI). That is to say, in the UASP protocol, the Universal Serial Bus can support multi-port storage media, and does not wait for complete transmission of current data or a current command before the Universal Serial Bus transmits subsequent data or a subsequent command. Therefore, transmission efficiency of the Universal Serial Bus is increased significantly.

Please refer to FIG. 1. FIG. 1 is a diagram illustrating handshaking between a Universal Serial Bus and a storage medium in the UASP protocol according to the prior art. As shown in FIG. 1, a Universal Serial Bus 102 transmits a read data command 1022 and a write data command 1024 to a storage medium 104. The read data command 1022 includes a command tag “128” and a number “0”, and the write data command 1024 includes a command tag “129” and a number “0”. After receiving the read data command 1022 and the write data command 1024, the storage medium 104 returns a read ready command 1042 and a write ready command 1044 to the Universal Serial Bus 102. The read ready command 1042 includes the command tag “128”, and the write ready command 1044 includes the command tag “129”. Therefore, data 1026 with the command tag “129” can be written to the storage medium 104 through the Universal Serial Bus 102, and data 1046 with the command tag “128” can be read from the storage medium 104 through the Universal Serial Bus 102.

As shown in FIG. 1, in the UASP protocol, the Universal Serial Bus 102 can simultaneously transmit at least one read data command and/or at least one write data command to the storage medium 104. Therefore, the storage medium 104 can simultaneously execute a read data command and a write data command.

Please refer to FIG. 2. FIG. 2 is a diagram illustrating handshaking between a Universal Serial Bus and two storage media in the UASP protocol according to the prior art. As shown in FIG. 2, the Universal Serial Bus 202 transmits a write data command 2022 to a storage medium 204 and a write data command 2024 to a storage medium 206 respectively. According to the UASP protocol, the write data command 2022 includes a command tag “128” and a number “0”, and the write data command 2024 includes a command tag “129” and a number “1”. After receiving the write data command 2022, the storage medium 204 returns a write ready command 2042 to the Universal Serial Bus 202. After receiving the write data command 2024, the storage medium 206 returns a write ready command 2062 to the Universal Serial Bus 202. The write ready command 2042 includes the command tag “128”, and the write ready command 2062 includes the command tag “129”. Therefore, when data 2026 with the command tag “128” is transmitted through the Universal Serial Bus 102, the Universal Serial Bus 102 can not determine whether the data 2026 with the command tag “128” is transmitted to the storage medium 204 or the storage medium 206. In the prior art, a number included in a write data command does not correspond to a predetermined storage medium, and data only includes a command tag. In order to overcome the above mentioned problem, the Universal Serial Bus 202 first performs handshaking between the Universal Serial Bus 202 and one of the two storage media 204, 206, then the Universal Serial Bus 202 performs another handshaking between the Universal Serial Bus 202 and the other of the two storage media 204, 206.

### SUMMARY OF THE INVENTION

An embodiment provides a system for realizing multi-port storage media based on a UASP protocol of a USB specification version 3.0. The system includes a Universal Serial Bus, at least one storage media, and a storage device. The Universal Serial Bus is used for transmitting at least one write data command, where each write data command a command tag and a number mapping to the command tag, and each number corresponds to a storage medium. The at least one storage media is coupled to the Universal Serial Bus, each storage medium for replying with a write ready command to the Universal Serial Bus after receiving the write data command, where the write ready command includes the command tag corresponding to the write data command. The storage device is coupled to the Universal Serial Bus, where the storage device includes a mapping table, where the mapping table stores each command tag and a number thereof according to each write data command. When the Universal Serial Bus transmits data including a command tag according to the write ready command, the storage device, the storage device finds a number mapping to the command tag according to the command tag and the mapping table, and transmits the data to a storage medium mapping to the number.

Another embodiment provides a system for realizing multi-port storage media based on a UASP protocol of a USB specification version 3.0. The system includes a Universal Serial Bus and a storage device. The Universal Serial Bus is used for transmitting a first write data command to a first storage medium, and transmitting a second write data command to a second storage medium. The first write data command includes a first command tag and a first number, and the second write data command includes a second command tag and a second, where the first number corresponds to the first storage medium and the second number corresponds to the second storage medium. The storage device is coupled to the Universal Serial Bus. The storage device stores a mapping table, where the mapping table includes a mapping relationship between the first command tag and the first number and a mapping relationship between the second command tag and the second number. When the Universal Serial Bus transmits data, the storage device transmits the data to the first storage medium or the second storage medium according to a command tag included in the data and the mapping table.

Another embodiment provides a method of realizing multi-port storage media based on a UASP protocol of a USB specification version 3.0. The method includes a Universal Serial Bus transmitting at least one write data command to at least one storage medium; the at least one storage medium replying with at least one write ready command to the Universal Serial Bus; looking up a number of a storage medium corresponding to a command tag included in data to be transmitted by a storage device; writing the data to the storage medium corresponding to the number.

The present invention provides a system for realizing the multi-port storage media based on a UASP protocol of a USB specification version 3.0 and the method thereof. The system and the method utilize a mapping table to map each command tag to a number of a storage medium corresponding to the command tag, so that data with a command tag can be written to a storage medium corresponding to the command tag. Thus, the present invention can realize a function of multi-port storage media based on a UASP protocol of a USB specification version 3.0.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating handshaking between a Universal Serial Bus and a storage medium in the UASP protocol according to the prior art.

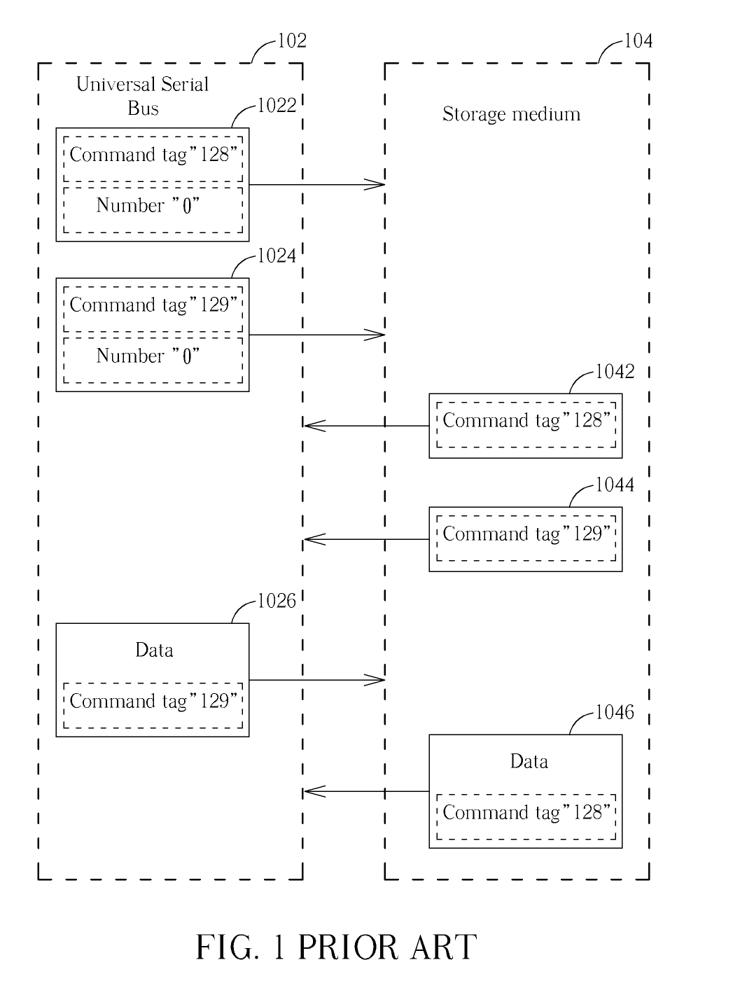

FIG. 2 is a diagram illustrating handshaking between a Universal Serial Bus and two storage media in the UASP protocol according to the prior art.

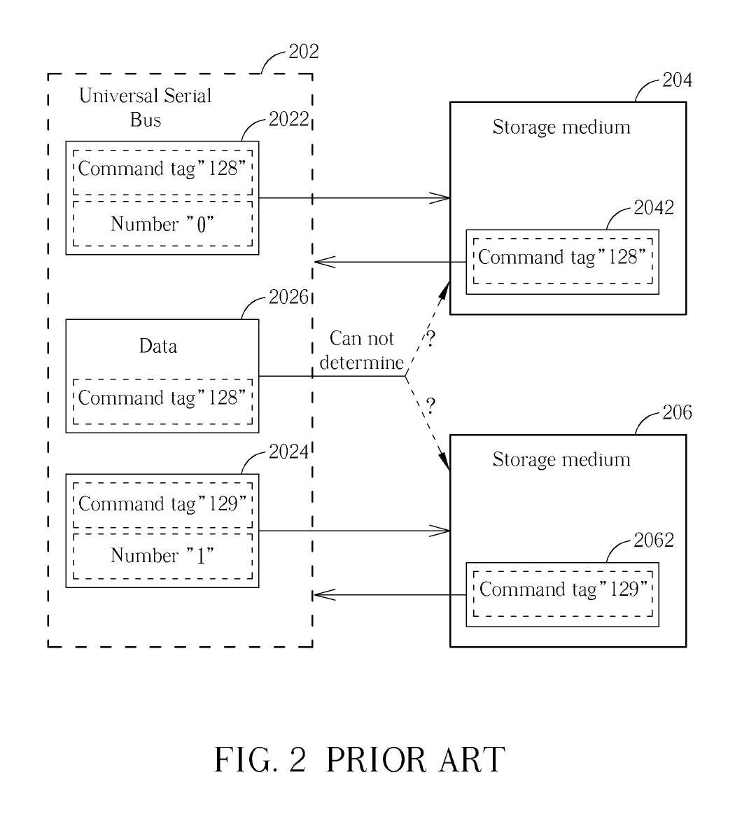

FIG. 3 is a diagram a system for realizing multi-port storage media based on a UASP protocol of a USB specification version 3.0 according to an embodiment.

FIG. 4 is a diagram illustrating the storage device.

FIG. 5 is a flowchart illustrating a method of realizing multi-port storage media based on a UASP protocol of a USB specification version 3.0 according to another embodiment.

### DETAILED DESCRIPTION

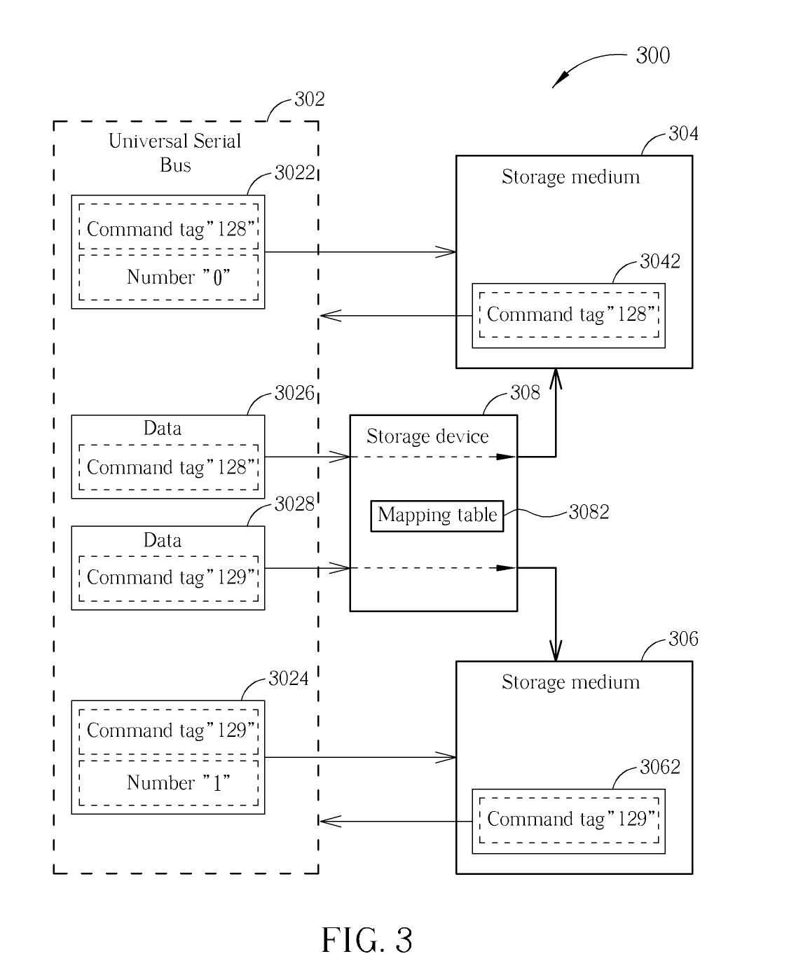

Please refer to FIG. 3. FIG. 3 is a diagram illustrating a system 300 for realizing multi-port storage media based on a UASP protocol of a USB specification version 3.0 according to an embodiment. The system 300 includes a Universal Serial Bus 302, two storage media 304, 306, and a storage device 308. The Universal Serial Bus 302 is used for transmitting at least one read data command or at least one write data command, where each read data command or each write data command includes a command tag and a number mapping to the command tag. The storage media 304, 306 are used for replying with a read ready command or a write ready command to the Universal Serial Bus 302 after receiving a read data command or a write data command, where the read ready command includes the command tag corresponding to the read data command, and the write ready command includes the command tag corresponding to the write data command. The storage device 308 is coupled to the Universal Serial Bus 302. The storage device 308 stores each command tag and a number corresponding to the command tag according to each write data command. When the Universal Serial Bus 302 transmits data including a command tag according to a write ready command, the storage device 308 finds a number mapped to the command tag according to the command tag and the mapping table 3082, and transmits the data to a storage medium corresponding to the number. In addition, the storage media 304, 306 are only used for describing the present invention clearly. That is to say, the present invention is not limit to two storage media. In addition, the storage media 304, 306 are two hard disks, two memories, or a combination thereof.

Initially, a driver of the Universal Serial Bus 302 can utilize a “Get MAX LUN” command to know how many storage media are coupled to the Universal Serial Bus 302, and transmit number of the storage media to an operating system. As shown in FIG. 3, when an operating system writes first data to the storage medium 304 and second data to the storage medium 306, the Universal Serial Bus 302 transmits a write data command 3022 to the storage medium 304 and a write data command 3024 to the storage medium 306 respectively. The write data command 3022 includes a command tag “128” and a number “0” corresponding to the storage medium 304, and the write data command 3024 includes a command tag “129” and a number “1” corresponding to the storage medium 306. After receiving the write data command 3022, the storage medium 304 returns a write ready command 3042 to the Universal Serial Bus 302, and after receiving the write data command 3024, the storage medium 306 returns a write ready command 3062 to the Universal Serial Bus 302. Because the write ready command 3042 corresponds to the write data command 3022, the write ready command 3042 includes the command tag “128”, and because the write ready command 3062 corresponds to the write data command 3024, the write ready command 3062 includes the command tag “129”.

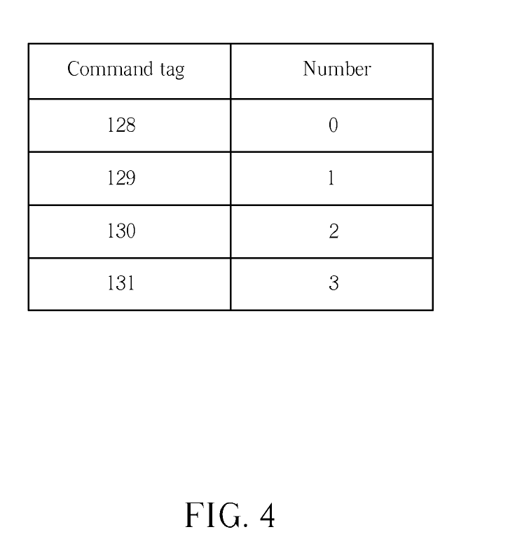

Please refer to FIG. 4. FIG. 4 is a diagram illustrating the storage device 308. As shown in FIG. 4, each command tag maps to a number of a storage medium corresponding to the command tag. That is to say, each command tag corresponds to a number of a storage medium. For example, the command tag “128” maps to the number “0” corresponding to the storage medium 304, the command tag “129” maps to the number “1” corresponding to the storage medium 306, and so on. But, the present invention is not limited to the storage device 308 having four command tags and four numbers. Therefore, as shown in FIG. 3, when first data 3026 with the command tag “128” are transmitted through the Universal Serial Bus 302, the first data 3026 with the command tag “128” are mapped to the number “0” according to the mapping table 3082 of the storage device 308. And, because the number “0” corresponds to the storage medium 304, the first data 3026 with the command tag “128” are written to the storage medium 304. Similarly, when second data 3028 with the command tag “129” are transmitted through the Universal Serial Bus 302, the second data 3028 with the command tag “129” are mapped to the number “1” according to the mapping table 3082 of the storage device 308. And, because the number “1” corresponds to the storage medium 306, the second data 3028 with the command tag “129” are written to the storage medium 306. In addition, the command tag “129” and the command tag “128” are only used to describing the present invention clearly. That is, the present invention is not limited to the numbers corresponding to the command tag “129” and the command tag “128”.

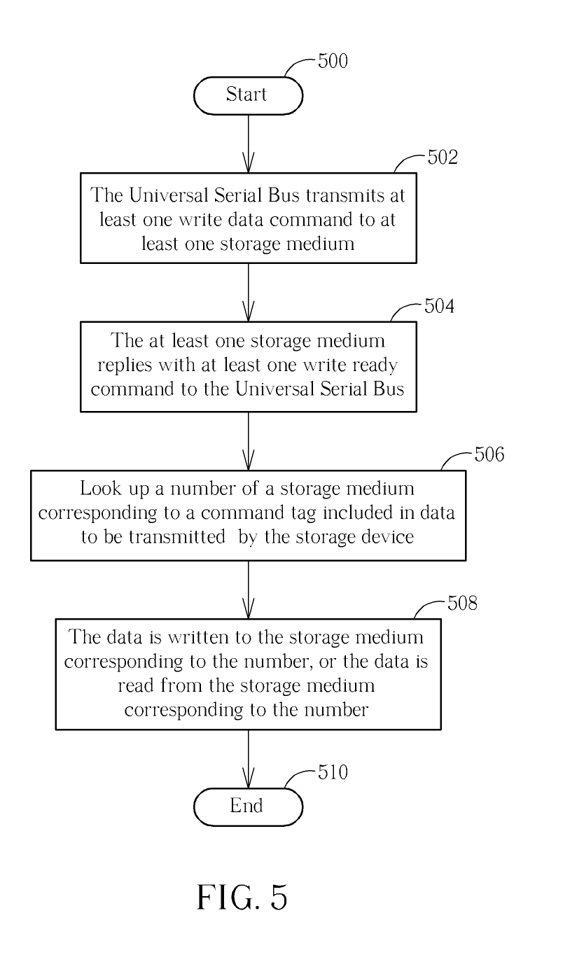

Please refer to FIG. 5. FIG. 5 is a flowchart illustrating a method of realizing multi-port storage media based on a UASP protocol of a USB specification version 3.0 according to another embodiment. FIG. 5 uses the system 300 of FIG. 3 to illustrate the method. Detailed steps are as follows:

Step 500: Start.

Step 502: The Universal Serial Bus 302 transmits at least one write data command to at least one storage medium.

Step 504: The at least one storage medium replies with at least one write ready command to the Universal Serial Bus 302.

Step 506: Look up a number of a storage medium corresponding to a command tag included in data to be transmitted by the storage device.

Step 508: The data is written to the storage medium corresponding to the number, or the data is read from the storage medium corresponding to the number.

Step 510: End.

In Step 502, each command includes a command tag corresponding to the command and a number corresponding to a storage medium. As shown in FIG. 3, the write data command 3022 includes the command tag “128” and the number “0” corresponding to the storage medium 304, and the write data command 3024 includes the command tag “129” and the number “1” corresponding to the storage medium 306. The mapping table 3082 of the storage device 308 is established for later look-up according to a command tag and a number of each command. In Step 504, each read ready command corresponds to a read data command, and the read ready command includes a command tag corresponding to the read data command. Each write ready command corresponds to a write data command, and the write ready command includes a command tag corresponding to the write data command. As shown in FIG. 3, the write ready command 3042 corresponds to the write data command 3022, so the write ready command 3042 includes the command tag “128”. The write ready command 3062 corresponds to the write data command 3024, so the write ready command 3062 includes the command tag “129”. In Step 506 and Step 508, the data with the command tag “128” are written to the storage medium 304 and the data with the command tag “129” are written to the storage medium 306 according to the mapping table 3082 of the storage device 308.

To sum up, the system for realizing the multi-port storage media based on the UASP protocol of the USB specification version 3.0 and the method thereof utilize the mapping table to map each command tag to a number of a storage medium corresponding to the command tag, so that data with a command tag can be written to a storage medium corresponding to the command tag. Thus, the present invention can realize multi-port storage media functionality based on the UASP protocol of the USB specification version 3.0.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for realizing multi-port storage media based on a UASP protocol of a USB specification version 3.0, the system comprising:
a Universal Serial Bus for transmitting at least one write data command, wherein each write data command comprises a command tag and a number mapping to the command tag, and each number corresponds to a storage medium;
at least one storage medium coupled to the Universal Serial Bus, each storage medium for replying with a write ready command to the Universal Serial Bus after receiving the write data command, wherein the write ready command comprises the command tag corresponding to the write data command; and
a storage device coupled to the Universal Serial Bus, the storage device comprising a mapping table, wherein the mapping table stores each command tag and a number thereof according to each write data command;
wherein when the Universal Serial Bus transmits data including a command tag according to the write ready command, the storage device finds a number mapping to the command tag according to the command tag and the mapping table, and transmits the data to a storage medium mapping to the number.

2. A system for realizing multi-port storage media based on a UASP protocol of a USB specification version 3.0, the system comprising:
a Universal Serial Bus for transmitting a first write data command to a first storage medium, and transmitting a second write data command to a second storage medium, the first write data command comprising a first command tag and a first number, the second write data command comprising a second command tag and a second number, wherein the first number corresponds to the first storage medium and the second number corresponds to the second storage medium; and
a storage device coupled to the Universal Serial Bus, the storage device comprising a mapping table, wherein the mapping table comprises a mapping relationship between the first command tag and the first number and a mapping relationship between the second command tag and the second number;
wherein when the Universal Serial Bus transmits data, the storage device transmits the data to the first storage medium or the second storage medium according to a command tag included in the data and the mapping table.

3. A method for realizing multi-port storage media based on a UASP protocol of a USB specification version 3.0, the method comprising:
a Universal Serial Bus transmitting at least one write data command to at least one storage medium;
the at least one storage medium replying with at least one write ready command to the Universal Serial Bus;
looking up a number of a storage medium corresponding to a command tag included in data to be transmitted by a storage device; and
writing the data to the storage medium corresponding to the number.

4. The method of claim 3, wherein each write data command comprises a command tag corresponding to the write data command and a number mapping to the command tag, and each number corresponds to a storage medium.

5. The method of claim 3, wherein each write ready command corresponds to a write data command, and the write ready command comprises a command tag of the write data command.

6. The method of claim 3, wherein the storage device maps each command tag to a number of a storage medium corresponding to the command tag.
